(19) United States
(12) Patent Application Publication
(10) Pub. No.: US 2012/0207536 A1
(43) Pub. Date: Aug. 16, 2012

(54) ANTI-CORROSION COATING FOR BALL JOINT

(75) Inventors: Bryan D. Wilson, Warren, MI (US); Eric B. Hoyer, White Lake, MI (US)

(73) Assignee: GM GLOBAL TECHNOLOGY OPERATIONS LLC, Detroit, MI (US)

(21) Appl. No.: 13/025,228

(22) Filed: Feb. 11, 2011

(51) Int. Cl. F16C 11/06

(52) U.S. Cl. 403/122

(57) ABSTRACT

A ball joint assembly includes a shaft having ball at an end of the shaft. A component, such as an idler arm, a tie rod, a central link, or other steering or suspension component, has a socket with an open end for receiving the ball. An end cap is mounted in the open end of the component to close the open end and thereby capture the ball within the socket for swiveling movement. An anti-corrosion coating coats the end cap to seal the end cap to the component and prevent corrosion between the end cap and the component.

### FIELD OF THE INVENTION

The invention relates to a ball joint in a motor vehicle and more particularly provides a specialized coating on the ball joint cap to both seal the joint and prevent galvanic corrosion.

### BACKGROUND OF THE INVENTION

Motor vehicle steering systems commonly employ ball and socket joints at various locations, including tie rods, idler arms, and center links. A typical ball and socket joint will include a shaft having a cylindrical ball at the end thereof and a component, such as an arm, having a socket for receiving the ball. A cap is installed on the arm to close the socket so that the cylindrical ball will remain captured within the socket. In some applications, a grease fitting is provided so that lubrication can be provided to the interface between the ball and the socket. In other cases, the ball and socket joint is completely sealed and a plastic bearing fits between the ball and the socket to provide a low friction connection. In either case, whether the ball joint is lubricated or permanently sealed, it is important to the long-term reliability of the ball joint that the end cap be reliably joined to the socket member in a fashion that will provide an effective sealing and also prevent corrosion. Effective sealing and corrosion prevention are difficult given the fact that vehicle steering systems are constantly exposed to extreme conditions of exposure to dirt, road salt, etc. In addition, the use of dissimilar materials, such as providing a ball joint of ferrous material and a component arm of aluminum, may promote the occurrence of galvanic corrosion.

Accordingly, it would be desirable to provide an improved ball joint structure for a vehicle steering systems in which the end cap is both effectively sealed and prevented from corroding.

### SUMMARY OF THE INVENTION

A ball joint assembly includes a shaft having a ball at an end of the shaft. A component, such as an idler arm, a tie rod, a central link ,or other steering or suspension component, has a socket with an open end for receiving the ball. An end cap is mounted in the open end of the component to close the open end and thereby capture the ball within the socket for swiveling movement. An anti-corrosion coating coats the end cap to seal the end cap to the component and prevent corrosion between the end cap and the component.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is a section view taken through a ball joint;

FIG. 2 is a fragmentary exploded view showing an end cap poised for mounting on a component arm; and,

FIG. 3 is a fragmentary view showing the end cap mounted on the component arm.

### DETAILED DESCRIPTION OF THE EXEMPLARY EMBODIMENTS

The following description of certain exemplary embodiments is exemplary in nature and does not limit the invention, its application, or uses.

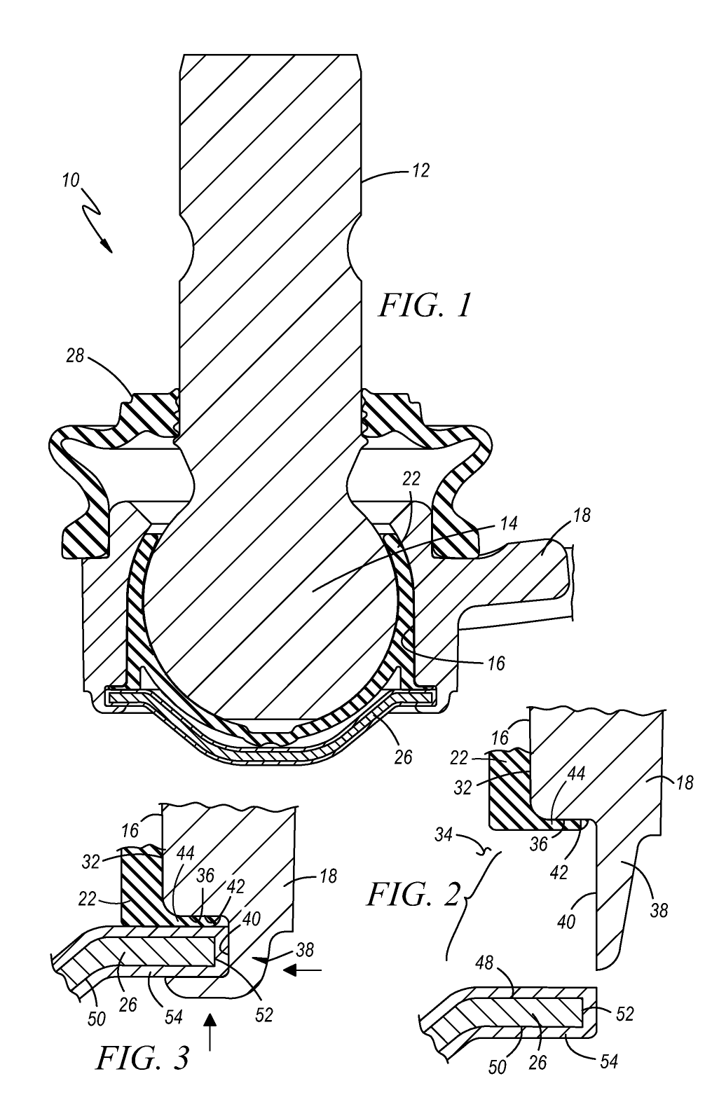

Referring to FIG. 1, a ball joint 10 includes a shaft 12 having a spherical ball 14 provided integrally on the end thereof. The ball 14 is captured within a socket 16 of a component arm 18. The component arm 18 may be an idler arm, a tie rod, a central link, or some other part of a vehicle steering or suspension system. A plastic bearing 22 is interposed between the ball 14 and socket 16 to provide low friction swiveling movement of the ball 14 within the component arm 18. An end cap 26 is permanently attached to the component arm 18 to close the open end of socket 16, thereby capturing the ball 14 and the bearing 22 within the socket 16. A rubber boot 28 is mounted on the component arm 18 and the shaft 12 to seal against the entry of dirt. The component arm may be of aluminum or ferrous metal.

As best seen in FIG. 2, the socket 16 of the component arm 18 includes a cylindrical wall 32 that defines an open end 34. The cylindrical wall 32 terminates at an abutment end wall 36 that is surrounded by a flange 38. The flange 38 has an inner flange wall 40 that extends from the abutment end wall 36. Thus, as seen in FIG. 2, the abutment end wall 36 and the inner flange wall 40 cooperate to define a pocket 42.

As seen in FIG. 2, the bearing 22 has a lip 44 that extends around the circumference of the bearing 22 and fits within the pocket 42 so that the lip 44 seats against the abutment end wall 36 and the inner flange wall 40. FIG. 2 also shows the end cap 26 poised for mounting within the pocket 42 defined by the abutment end wall 36 and the inner flange wall 40. The end cap 26 is a circular disk of metallic material, preferably ferrous metal.

The end cap 26 has an inside face 48, and outside face 50, and a rim face 52. The end cap 26 is fitted into the pocket 42 of the component arm 18, and the flange 38 will be spun over onto the outside face 50 of the end cap 26 so that the end cap 26 becomes tightly captured and retained within the pocket 42. Thus, with the end cap 26 permanently installed onto the component arm 18, the open end 34 of socket 16 of the component arm 18 has been closed and the bearing 22 and the ball stud shaft 12 are permanently retained in a swiveling relationship within the component arm 18.

It is characteristic of the aforedescribed ball joint assembly that over time, the joint will be adversely influenced by dirt and corrosion. Although the end cap 26 is tightly held in place, the metallic materials, most often ferrous metal, from which the end cap 26 is constructed, will have small pits, fissures, and other barely visible imperfections in the surfaces thereof, through which, over time, dirt and corrosion can infiltrate. The corrosion can be an environmental corrosion, caused by moisture and salt. Alternatively, the corrosion can be galvanic corrosion, such as, for example, when the component arm 18 is made of aluminum and the end cap 26 is made of ferrous metal.

Referring again to FIG. 2, it is seen that the end cap 26 is coated by a specialized anti-corrosion coating 54 that covers the entire surface of the end cap 26 including the inside face 48, outside face 50, and the rim face 52. The coating is preferably one of the commercially available coatings that are effective to resist corrosion but also to fill the small pits, fissures, and other surface imperfections in the surfaces of the end cap 26. For example, a suitable coating is the aluminized coating sold under the name Sermaguard by the Praxair Surface Technologies Inc., 1500 Polco Street, Indianapolis, Ind. 46222. Sermaguard is a composite coating consisting of binders combined with metallic, ceramic, or thermoplastic materials. The binder system is a water-based inorganic material that cures at a low temperature to produce a ceramic bonding matrix. By choosing additive materials and topcoat materials, Sermaguard can provide optimized corrosion resistance and sealing characteristics.

Another suitable coating is an abradable power coat coating sold under the trade name of Slick CC by Line-2-Line Coatings, Inc., 6650 Highland Rd., Unit 204, Waterford, Mich. 48327. Slick CC is a two-part coating system consisting of a primer coat and a top powder coat. The primer is typically epoxy-based and functions as a bonding agent between the metal and the powder coat and provides environmental corrosion protection. The powder coat is also epoxy based and contains thermoset resins, fillers, and modifiers. The powder coat material acts as a sealing gasket by displacing into and filling the surface imperfections under the pressure created by the spin-over process that spins the flange 38 onto the cap 26. The powder coat is preferably applied with a thickness range of 0.005 to 0.020 inches. The powder coat will also act as a barrier between the dissimilar aluminum and ferrous materials to prevent galvanic corrosion.

FIG. 3 shows the fully assembled ball joint. The end cap 26 has been placed into the pocket 42 of the component arm 18 and the flange 38 has been spun inwardly to attach the end cap 26 to the component arm 18. In particular, as seen in FIG. 3, the coated inside face 48 of end cap 26 is tightly engaged against the lip 44 of the bearing 22, and, in turn, tightly engages the lip 44 against the abutment end wall 36 of component arm 18. The coated rim face 52 of the end cap 26 is tightly engaged by the inner flange wall 40 of the flange 38. In addition, the coated outer face 50 of the end cap 26 is tightly engaged by the inner flange wall 40 of flange wall 38 due to the flange 38 having been spun onto the end cap 26. Accordingly, the three separate coated surfaces 48, 50 and 52 act as three separate sealed interfaces through which dirt or corrosion must successively penetrate in order to penetrate to the ball 14.

What is claimed is:

1. A ball joint assembly comprising:
a shaft having a ball at an end of the shaft;
a component having a socket therein for receiving the ball, said socket having an open end;
an end cap mounted in the open end of the component to close the open end and thereby capture the ball within the socket for swiveling movement;
and an anti-corrosion coating coated on the end cap to seal the end cap to the component and prevent galvanic corrosion between the end cap and the component.

2. The ball joint assembly of claim 1 further comprising the anti-corrosion coating being a composite coating consisting of a water-based binder of inorganic material that cures at a low temperature to produce a ceramic bonding matrix, combined with metallic, ceramic, or thermoplastic materials.

3. The ball joint assembly of claim 1 further comprising the anti-corrosion coating being a composite coating consisting of a water-based binder of inorganic material that cures at a low temperature to produce a ceramic bonding matrix, combined with metallic, ceramic, or thermoplastic material.

4. The ball joint of claim 1 further comprising the end cap and the component being of dissimilar metals and the anti-corrosion coating preventing galvanic corrosion.

5. A ball joint assembly comprising:
a shaft having a ball at an end of the shaft;
a component having a socket therein for receiving the ball, said socket having a cylindrical wall defining an open end through which the ball is installed, the cylindrical wall defining at the open end an end face including a radially inboard abutment wall and a flange wall that is radially outboard of the abutment wall and extends from the abutment wall in the direction of the axis of the cylindrical wall;
a disc-shaped end cap for mounting in the open end of the component to close the open end and thereby capture the ball within the socket, said end cap having an inside face, and outside face, and a rim face;
an anti-corrosion coating coated on the end cap, including coating the inside face, the outside face, and the rim face; and,
said end cap having a portion of the inside face seated on the end face of the component and said flange of the component being spun inwardly to overlie the disc with the flange forcefully engaging the outside face and rim face of the desk and also forcefully engaging the inside face with the end face of the component so that the outside face, the rim face, and the inside face provide three separate seals that seal the socket.

6. The ball joint assembly of claim 1 further comprising the anti-corrosion coating being a composite coating consisting of a water-based binder of inorganic material that cures at a low temperature to produce a ceramic bonding matrix, combined with metallic, ceramic, or thermoplastic material.

7. The ball joint assembly of claim 1 further comprising the anti-corrosion coating being a two part coating system consisting of an epoxy-based primer coat and a top powder coat containing thermoset resins, fillers, and modifiers.

8. The ball joint assembly of claim 1 further comprising the end cap and the component being of dissimilar metals and the anti-corrosion coating preventing galvanic corrosion.

9. A ball joint assembly comprising:
a shaft having a ball at an end of the shaft;
a component having a socket therein for receiving the ball, said socket having a cylindrical wall defining an open end through which the ball is installed, the cylindrical wall defining at the open end an end face including a radially inboard abutment wall and a flange wall that is radially outboard of the abutment wall and extends from the abutment wall in the direction of the axis of the cylindrical wall;
a disc-shaped end cap for mounting in the open end of the component to close the open end and thereby capture the ball within the socket, said end cap having an inside face, and outside face, and a rim face;
an anti-corrosion coating coated on the end cap, including coating the inside face, the outside face, and the rim face, said anti-corrosion coating being a composite coating consisting of a water-based binder of inorganic material that cures at a low temperature to produce a ceramic bonding matrix, combined with metallic, ceramic, or thermoplastic material; and,
said end cap having a portion of the end inside face seated on the end face of the component and said flange of the component being spun inwardly to overlie the disc with the flange forcefully engaging the outside face and rim face of the disc and also forcefully engaging the inside face with the end face of the component so that the outside face, the rim face, and the inside face to provide three separate seals that seal the socket.

10. A ball joint assembly comprising:
a shaft having a ball at an end of the shaft;
a component having a socket therein for receiving the ball, said socket having a cylindrical wall defining an open end through which the ball is installed, the cylindrical wall defining at the open end an end face including a radially inboard abutment wall and a flange wall that is radially outboard of the abutment wall and extends from the abutment wall in the direction of the axis of the cylindrical wall;
a disc-shaped end cap for mounting in the open end of the component to close the open end and thereby capture the ball within the socket, said end cap having an inside face, and outside face, and a rim face;
an anti-corrosion coating coated on the end cap, including coating the inside face, the outside face, and the rim face, the anti-corrosion coating being a two-part coating system consisting of an epoxy-based primer coat and a top powder coat containing thermoset resins, fillers, and modifiers; and,
said end cap having a portion of the end inside face seated on the end face of the component and said flange of the component being spun inwardly to overlie the disc with the flange forcefully engaging the outside face and rim face of the disc and also forcefully engaging the inside face with the end face of the component so that the outside face, the rim face, and the inside face provide three separate seals that seal the socket.
